(19) United States
(12) Patent Application Publication
(10) Pub. No.: US 2026/0211436 A1
(43) Pub. Date: Jul. 23, 2026

(54) BANDGAP REFERENCE CIRCUIT USING COMPLEMENTARY TO ABSOLUTE TEMPERATURE (CTAT) VOLTAGE WITH UNCORRELATED THRESHOLD-VOLTAGE DEVICES

(71) Applicant: TAIWAN SEMICONDUCTOR MANUFACTURING COMPANY LTD., HSINCHU (TW)

(72) Inventors: CHIN-HO CHANG, HSINCHU CITY (TW); CHU-EN HSIA, HSINCHU (TW); CHING LIN JEN, HSINCHU COUNTY (TW); YUNG-CHOW PENG, HSINCHU (TW)

(21) Appl. No.: 19/199,283

(22) Filed: May 5, 2025

Related U.S. Application Data
(60) Provisional application No. 63/746,261, filed on Jan. 17, 2025.

(51) Int. Cl. G05F 1/567

(52) U.S. Cl. CPC G05F 1/567

(57) ABSTRACT

A voltage reference circuit is provided, which includes a first voltage source and a second voltage source. The first voltage source is configured to generate a first voltage which monotonically decreases with an absolute temperature of the voltage reference circuit. The second voltage source is configured to generate a second voltage, which monotonically increases with the absolute temperature of the voltage reference circuit. The second voltage is compensated with the first voltage to generate a reference voltage. The first voltage source includes a first temperature-sensitive device and a second temperature-sensitive device. The first temperature-sensitive device is of a first type, and the second temperature-sensitive device is of a second type. These devices are arranged in a cascode structure. The first voltage at an output terminal of the first voltage source equals to a third voltage across the first temperature-sensitive device plus a fourth voltage across the second temperature-sensitive device.

### CROSS-REFERENCE TO RELATED APPLICATION(S)

This application claims the benefit of U.S. Provisional Application No. 63/746,261, filed Jan. 17, 2025, the entire disclosure of which is incorporated by reference herein.

### BACKGROUND

The current trend in miniaturizing integrated circuits (ICs) has led to the development of smaller, more efficient devices with increased functionality and higher operating speeds. This miniaturization process has also brought about more stringent design and manufacturing requirements, as well as reliability challenges. Electronic design automation (EDA) tools are utilized to create, optimize, and validate standard cell layout designs for integrated circuits, ensuring that they meet both design and manufacturing specifications.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of a voltage reference circuit in accordance with some embodiments of the present disclosure.

FIG. 2 is a diagram illustrating the voltage compensation of a voltage reference circuit in accordance with some embodiments of the present disclosure.

FIG. 3A is a circuit diagram of a voltage source in accordance with an embodiment of the present disclosure.

FIG. 3B is a circuit diagram of a voltage source in accordance with another embodiment of the present disclosure.

FIG. 3C is a diagram illustrating the relationships between voltages VCTATP and VCTATN in accordance with some embodiments of the present disclosure.

FIG. 4A is a circuit diagram of a voltage source in accordance with yet another embodiment of the present disclosure.

FIG. 4B is a circuit diagram of a voltage source in accordance with yet another embodiment of the present disclosure.

FIG. 5A is a diagram of a stacked gate device in accordance with some embodiments of the present disclosure.

FIG. 5B is an equivalent circuit diagram of the stacked gate device in FIG. 5A.

FIG. 6A is a schematic diagram of a stacked gate device in a diode-connected configuration in accordance with some embodiments of the present disclosure.

FIG. 6B is a diagram illustrating variations of a voltage-temperature curve of the stacked gate device in FIG. 6A.

FIGS. 7A-7D are circuit diagrams of a voltage source in accordance with different embodiments of the present disclosure.

FIGS. 8A-8B are circuit diagrams of a voltage source in accordance with different embodiments of the present disclosure.

FIG. 9 is a circuit diagram of a voltage reference circuit in accordance with some embodiments of the present disclosure.

FIG. 10 is a circuit diagram of a voltage reference circuit in accordance with some embodiments of the present disclosure.

FIG. 11 is a flowchart of a method for generating a power supply voltage with reduced temperature-correlation in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

A bandgap reference circuit provides a reference voltage that is steady over manufacturing process, temperature, or the supply voltage (PVT). Specifically, a bandgap reference circuit is designed to output the reference voltage within some tolerance, regardless of variations in PVT. The variation across PVT can be characterized by a number of bandgap coefficients such as a bandgap temperature coefficient. As semiconductor technology has advanced, transistor gate lengths, and the corresponding maximum supply voltage that the transistor can tolerate without breaking down, have become lower.

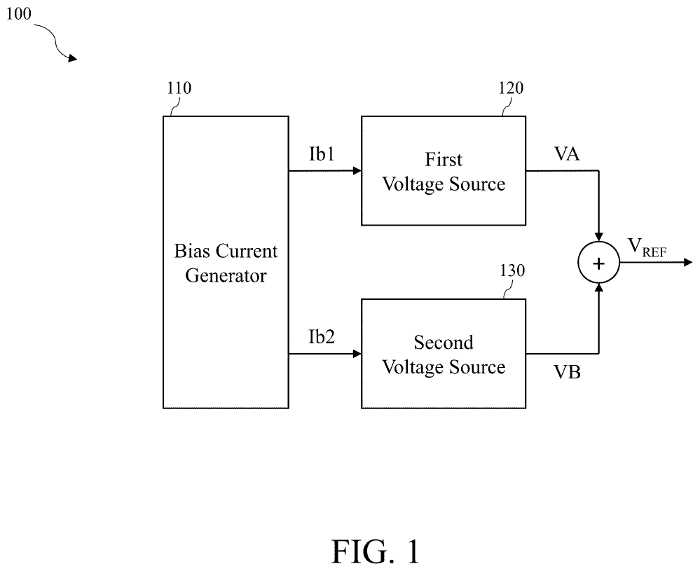

FIG. 1 is a block diagram of a voltage reference circuit in accordance with some embodiments of the present disclosure.

In some embodiments, the voltage reference circuit 100 is a bandgap reference (BGR) circuit implemented using metal oxide semiconductor field-effect transistors (MOSFET). The voltage reference circuit 100 includes at least a bias current generator 110, a first voltage source 120 and a second voltage source 130, as depicted in FIG. 1. The bias current generator 110 may be configured to generate a first bias current Ib1 and a second bias current Ib2 that are provided to the first voltage source 120 and the second voltage source 130, respectively.

In some embodiments, the first voltage source 120 may be configured to generate a first voltage VA, which monotonically decreases with an absolute temperature of the voltage reference circuit 100, based on the first bias current Ib1. The second voltage source 130 may be configured to generate a second voltage VB, which monotonically increases with the absolute temperature of the voltage reference circuit 100, based on the second bias current Ib2. Both the first voltage source 120 and the second voltage source 130 may include one or more metal-oxide semiconductor field-effect transistors (MOSFETs) and/or stacked gate devices of MOSFETs. In some embodiments, the MOSFETs used in the first voltage source 120 and the second voltage source 130 are not limited to SVT (standard threshold voltage) transistors. Additionally or alternatively, HTV (high threshold voltage), LVT (low threshold voltage), SLVT (super-low threshold voltage), ULVT (ultra-low threshold voltage), and ELVT (extremely-low threshold voltage) transistors can also be used. In some embodiments, the SVT, LVT, SLVT, ULVT, ELVT, and HVT devices are fabricated using different processes, resulting in different variations of their gate-to-source voltage with respect to the absolute temperature.

In some embodiments, an SVT device may have a threshold voltage ranging from approximately 0.3V to 0.35V. An LVT device may have a threshold voltage ranging from approximately 0.2V to 0.25V. An ULVT device may have a threshold voltage ranging from approximately 0.1V to 0.15V. An ELVT device may have a threshold voltage less than 0.1V.

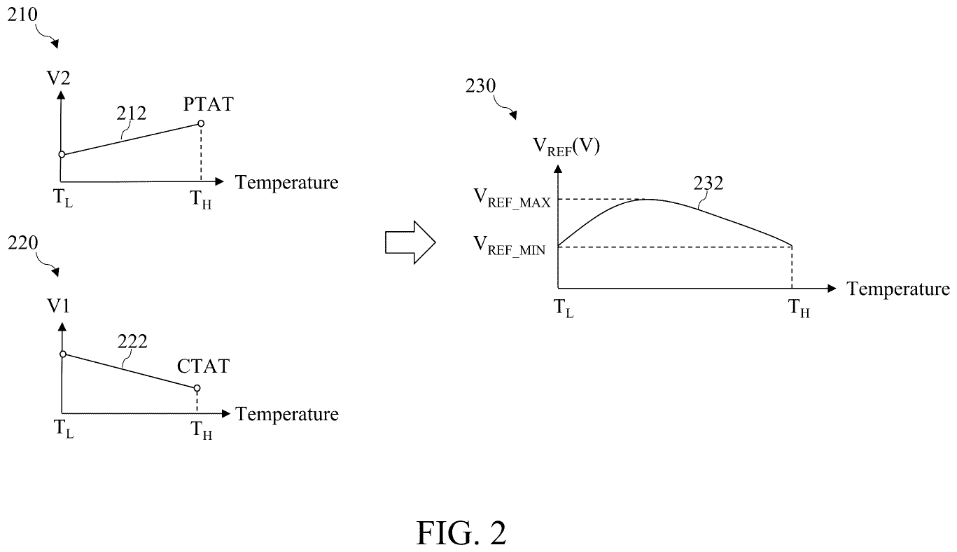

The first voltage VA is compensated with the second voltage VB to generate a reference voltage V_{REF}. The working principle of this compensation is detailed with reference to FIG. 2, which illustrates a voltage-temperature curve resulting from the compensation between the first voltage VA and the second voltage VB, in accordance with some embodiments of the present disclosure. In some embodiments, the first voltage VA is complementary to the absolute temperature (CTAT), whereas the second voltage VB is proportional to the absolute temperature (PTAT), as shown by curves 222 and 212 in diagrams 220 and 210, respectively. The compensation of the first voltage VA with the second voltage VB results in the generation of the reference voltage V_{REF}, which exhibits temperature-voltage relationships as depicted by curve 232 in diagram 230. It should be noted that the inaccuracy of the voltage VA generated by first voltage source 120 may contribute a large portion (e.g., approximately 60%) of the inaccuracy of the reference voltage V_{REF} generated by the voltage reference circuit 100.

Specifically, the voltage reference circuit 100 is designed to work within an operational temperature range defined by an upper temperature TH and a lower temperature TL, indicating that the reference voltage V_{REF} being suitable for all PVT (process, voltage, and temperature) combinations within the operation temperature range. In some embodiments, the upper temperature TH and the lower temperature TL may be 125° C. and −40° C., respectively, but the present disclosure is not limited thereto. The upper temperature TH and lower temperature TL can be adjusted according to practical needs. Additionally, the reference voltage V_{REF} is subject to variation between voltage V_{REF_MAX} and V_{REF_MIN} within the operational temperature range between the upper temperature TH and the lower temperature TL. Accordingly, the temperature coefficient TC of the reference voltage V_{REF} can be expressed using formula (1) as follows.

$$TC = \frac{{V}_{REF \_ MAX} - {V}_{REF \_ MIN}}{{V}_{REF \_ AVG} ( {T}_{H} - {T}_{L} )} \times 1 {0}^{6} ( ppm / ° C . ) \qquad ( 1 )$$

In formula (1), V_{REF_AVG}, which can be referred to as a nominal voltage Vₙₒₘᵢₙₐₗ, denotes the average temperature of the reference voltage V_{REF} at a specified temperature (often at the room temperature, e.g., 25° C.).

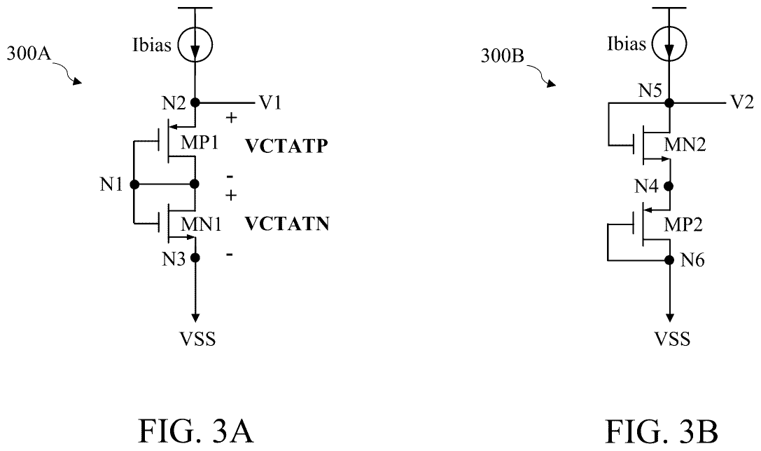

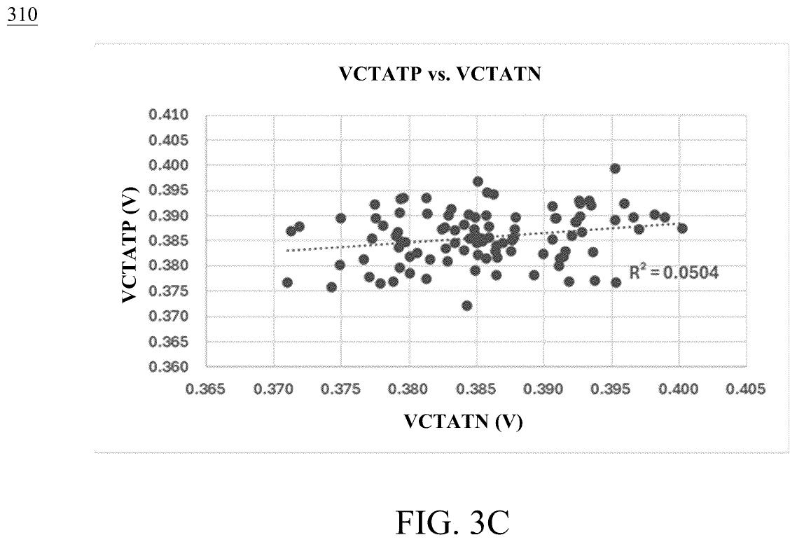

FIG. 3A is a circuit diagram of a voltage source in accordance with an embodiment of the present disclosure.

In some embodiments, the first voltage source 120 (e.g., a CTAT voltage source) of the voltage reference circuit 100 shown in FIG. 1 can be implemented using the voltage source 300A in FIG. 3A. It should be noted the voltage source 300A shown in FIG. 3A serves to describe the operations of the first voltage source 120 shown in FIG. 1, which may alternatively implemented by any other CTAT voltage source, as described with reference to FIGS. 3B, 4A, 4B, 7A-7D, and 8A-8B.

In some embodiments, the voltage source 300A is configured to generate a voltage V1 which is CTAT. For example, the voltage source 300A includes transistor MN1 of a first type and transistor MP1 of a second type arranged in a cascode structure, with a bias current Ibias flowing through transistor MP1 and MN1.

In some embodiments, a gate terminal of transistor MN1 is coupled to node N1. A first source/drain (S/D) terminal of transistor MN1 is coupled to node N1. A second S/D terminal is configured to receive a reference voltage or ground voltage VSS. In other words, transistor MN1 is in a diode-connected configuration (e.g., gate terminal of transistor MN1 connected to its drain terminal).

In some embodiments, a gate terminal of transistor MP1 is coupled node N1. A first S/D terminal of transistor MP1 is coupled to node N2, which serves as an output terminal of the voltage source 300A. A second S/D terminal of transistor MP1 is coupled to node N1. In other words, transistor MP1 is also in a diode-connected configuration (e.g., gate terminal of transistor MN1 connected to its drain terminal). Additionally, transistor MP1 has a common gate (e.g., node N1) with transistor MN1.

In some embodiments, the inaccuracy of the voltage V1 generated by the voltage source 300A can be defined as the ratio of the standard deviation of the voltage V1 to the mean of the voltage V1.

In the subthreshold region, where the transistor operates below its threshold voltage, the drain current (ID) is exponentially related to V_GS and can be expressed using formula (2).

$${I}_{D} = {I}_{D 0} {e}^{( \frac{{V}_{GS}}{{nV}_{T}} )} \qquad ( 2 )$$

In formula (1), V_{T} denotes the thermal voltage, which is given by

$${V}_{T} = \frac{k T}{q} ,$$

where k is the Boltzmann's constant, T is the absolute temperature in kelvins, and q is the elementary charge.

In other words, when the bias current I is fixed, the threshold voltage Vth decreases as the temperature increases, causing the gate-to-source voltage V_{GS} of transistor MN1 (e.g., in the subthreshold region) to monotonically decrease with the absolute temperature (e.g., complementary to the absolute temperature, CTAT). Since the gate terminal and the first S/D terminal of transistor MN1 are coupled to node N1, the voltage VCTATN across the first S/D terminal and the second S/D terminal of transistor MN1 (e.g., drain-to-source voltage V_{DS} of transistor MN1) is CTAT.

In some embodiments, the gate-to-source voltage Vgs of transistor MP1 is also CTAT which is similar to that of transistor MN1. Since the gate terminal and the second S/D terminal of transistor MP1 are coupled to node N1, the voltage VCTATP across the first S/D terminal and the second S/D terminal of transistor MP1 (e.g., source-to-drain Vsd of transistor MP1) is CTAT. This indicates that both transistors MN1 and MP1 are temperature-sensitive devices. Therefore, the voltage V1 generated at node N1 is equal to the summation of voltages VCTATN and VCTATP, causing the voltage V1 generated by the voltage source 300A to be CTAT.

For brevity, it is assumed that both voltages VCTATP and VCTATN have similar means (e.g. μₚ=μₙ=μ), and variations (e.g., σₚ=σₙ=σ), the voltage V1 can be expressed as

$$V 1 = VCTATP + VCTATN = ( {μ}_{p} \pm {σ}_{p} ) + ( {μ}_{n} \pm {σ}_{n} ) = 2 μ \pm \sqrt{{σ}_{p}^{2} + {σ}_{n}^{2}} = 2 μ \pm \sqrt{{σ}^{2} + {σ}^{2}} = 2 μ \pm \sqrt{2} σ .$$

In other words, the voltage V1 generated by the voltage source 300 has a mean of 2μ and a variation of \sqrt{2}σ. Accordingly, the one-sigma inaccuracy of the voltage V1 can be calculated as

$$\frac{\sqrt{2} σ}{2 μ} = 0.7 \frac{σ}{μ} .$$

Therefore, the one-sigma inaccuracy of the voltage V1 is reduced by 30% compared to the CTAT voltage generated by a single N-type transistor.

In some approaches, two transistors of the same type and threshold voltage (e.g., N-type SVT transistors) in the diode-connected configurations may be arranged in a cascode structure to generate a CTAT voltage. However, a voltage across two S/D terminals of the first transistor and a voltage across of the second transistor may be highly correlated in such arrangement, resulting in slight reduction in inaccuracy of the generated CTAT voltage compared to the CTAT voltage generated by a single N-type transistor.

It should be noted that the relationships between voltages VCTATP and VCTATN are shown by diagram 310 in FIG. 3C. As can be seen from FIG. 3C, the relationships between the voltages VCTATP and VCTATN have a weak correlation, i.e., the coefficient of determination R² is approximately 0.0504. Therefore, the voltage V1 generated by the voltage source 300A can have a lower inaccuracy and a lower variation of the temperature coefficient. When the voltage source 300A is used in the voltage reference circuit 100, the inaccuracy and temperature coefficient of the reference voltage V_{REF} generated by the voltage reference circuit 100 can be significantly reduced, thereby improving the performance of the voltage reference circuit 100.

FIG. 3B is a circuit diagram of a voltage source in accordance with another embodiment of the present disclosure.

In some embodiments, the first voltage source 120 (e.g., a CTAT voltage source) of the voltage reference circuit 100 shown in FIG. 1 can be implemented using the voltage source 300B in FIG. 3B. The voltage source 300B is configured to generate a voltage V2 which is CTAT. For example, the voltage source 300B includes transistor MN2 of a first type and transistor MP2 of a second type arranged in a cascode structure, with a bias current Ibias flowing through transistor MN2 and MP2.

In some embodiments, a gate terminal of transistor MN2 is coupled to node N5, which serves as an output terminal of the CTAT voltage source 300B. A first S/D terminal of transistor MN2 is coupled to node N5. A second S/D terminal is coupled to node N4. In other words, transistor MN2 is in a diode-connected configuration. (e.g., gate terminal of transistor MN2 connected to its drain terminal).

In some embodiments, a gate terminal of transistor MP2 is coupled node N6. A first S/D terminal of transistor MP1 is coupled to node N4, which serves as an output terminal of the CTAT voltage source 300A. A second S/D terminal of transistor MP1 is coupled to node N1. In other words, transistor MP1 is also in a diode-connected configuration (e.g., gate terminal of transistor MN1 connected to its drain terminal). Additionally, the gate terminal (e.g., node N6) of transistor MP1 is separated from the gate terminal (e.g., node N5) of transistor MN1.

In some embodiments, the relationships between the drain-to-source voltage (e.g., V_{DS}) of transistor MN2 and the source-to-drain voltage (e.g., V_{SD}) of transistor MP2 shown in FIG. 3B have a weak correlation in a manner similar to transistors MN1 and MP1 shown in FIG. 3A. Therefore, the voltage V2 generated by the voltage source 300B can have a lower inaccuracy and a lower variation of the temperature coefficient. When the voltage source 300B is used in the voltage reference circuit 100, the inaccuracy and temperature coefficient of the reference voltage V_{REF} generated by the voltage reference circuit 100 can be significantly reduced, thereby improving the performance of the voltage reference circuit 100.

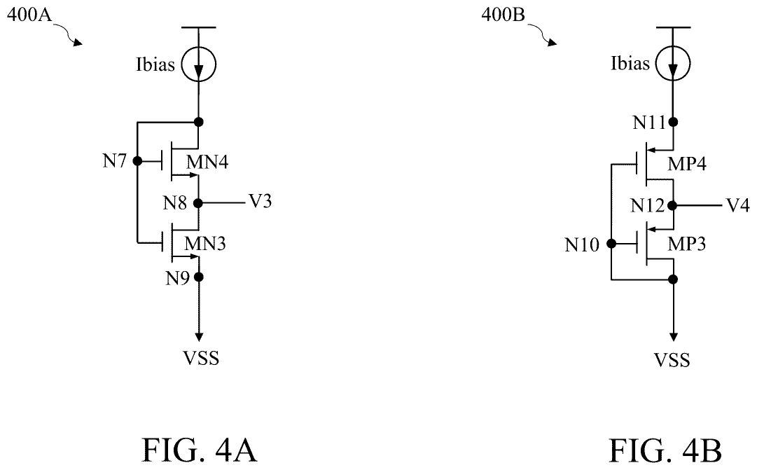

FIG. 4A is a circuit diagram of a voltage source in accordance with yet another embodiment of the present disclosure.

In some embodiments, the first voltage source 120 (e.g., a CTAT voltage source) of the voltage reference circuit 100 shown in FIG. 1 can be implemented using the voltage source 400A in FIG. 4A. The voltage source 400A is configured to generate a voltage V3 which is CTAT. For example, the voltage source 400A includes transistors MN3 and MN4 of a first type arranged in a common-gate cascode structure. In some embodiments, transistors MN3 and MN4 can be selected from the SVT, LVT, ULVT, ELVT, and HVT devices. Additionally, transistor MN3 has a lower threshold voltage than transistor MN4, i.e., V_{t_MN3}<V_{t_MN4}. In some embodiments, transistor MN4 is designed as one of an SVT device, an LVT device, and an ULVT device. In some embodiments, transistor MN4 is designed as an SVT device, while transistor MN3 is designed as an LVT device, an ULVT device, or an ELVT device. In some embodiments, transistor MN4 is designed as an LVT device, while transistor MN3 is designed as an ULVT device or an ELVT device. In some embodiments, transistor MN4 is designed as an ULVT device, while transistor MN3 is designed as an ELVT device.

In some embodiments, a gate terminal of transistor MN3 is coupled to node N7. A first S/D terminal of transistor MN3 is coupled to node N8, which serves as an output terminal of the voltage source 400A. A second S/D terminal of transistor MN3 is coupled to node N9, and is configured to receive a reference voltage or ground voltage VSS. It should be noted that transistor MN3 is not in a diode-connected configuration.

In some embodiments, a gate terminal of transistor MN4 is coupled to node N7. A first S/D terminal of transistor MN4 is coupled to node N7. A second S/D terminal of transistor MN4 is coupled to node N8. In other words, transistor MN4 is in a diode-connected configuration. (e.g., gate terminal of transistor MN4 connected to its drain terminal). Additionally, transistors MN3 and MN4 share the common gate (e.g., node N7).

In some embodiments, given that the fixed bias current Ibias flows through transistors M3 and M4, transistors MN3 and MN4 operate in the subthreshold region. The voltage V3 generated at node N8 is equal to V_{GS_MN3}−V_{GS_MN4}. Since the gate-to-source voltage V_{GS_MN4} of transistor MN4 with a higher threshold voltage is less sensitive to the absolute temperature compared to the gate-to-source voltage V_{GS_MN3} of transistor MN3 with a lower threshold voltage, the voltage V3 generated at node N8 is complementary to the absolute temperature (e.g., CTAT). Additionally, since transistors MN3 and MN4 are devices with different threshold voltages that are fabricated using different processes, the gate-to-source voltages V_{GS_MN3} and V_{GS_MN4} have a weak correlation or dependency with respect to the absolute temperature, thereby improving (i.e., reducing) the inaccuracy and temperature coefficient of the voltage V3 generated by the voltage source 400A.

FIG. 4B is a circuit diagram of a voltage source in accordance with yet another embodiment of the present disclosure.

In some embodiments, the first voltage source 120 (e.g., a CTAT voltage source) of the voltage reference circuit 100 shown in FIG. 1 can be implemented using the voltage source 400B in FIG. 4B. The voltage source 400B is configured to generate a voltage V4 which is CTAT. For example, the voltage source 400B includes transistors MP3 and MP4 of a second type arranged in a common-gate cascode structure. In some embodiments, transistors MP3 and MP4 can be selected from the SVT, LVT, ULVT, ELVT, and HVT devices. Additionally, transistor MP4 has a lower threshold voltage than transistor MP3, i.e., |V_{t_MP4}|<|V_{t_MP3}|. In some embodiments, transistor MP3 is designed as one of an SVT device, an LVT device, and an ULVT device. In some embodiments, transistor MP3 is designed as an SVT device, while transistor MP4 is designed as an LVT device, an ULVT device, or an ELVT device. In some embodiments, transistor MP3 is designed as an LVT device, while transistor MP4 is designed as an ULVT device or an ELVT device. In some embodiments, transistor MP3 is designed as an ULVT device, while transistor MP4 is designed as an ELVT device.

In some embodiments, a gate terminal of transistor MP3 is coupled to node N10. A first S/D terminal of transistor MP3 is coupled to node N12, which serves as an output terminal of the voltage source 400B. A second S/D terminal of transistor MP3 is coupled to node N10, and is configured to receive a reference voltage or ground voltage VSS. It should be noted that transistor MP3 is in a diode-connected configuration (e.g., gate terminal of transistor MP3 connected to its drain terminal).

In some embodiments, a gate terminal of transistor MP4 is coupled to node N10. A first S/D terminal of transistor MP4 is coupled to node N11. A second S/D terminal of transistor MN4 is coupled to node N12. It should be noted that transistor MP4 is not in a diode-connected configuration. Additionally, transistors MP3 and MP4 share the common gate (e.g., node N10).

In some embodiments, given that the fixed bias current Ibias flows through transistors MP4 and MP3, transistors MP3 and MP4 operate in the subthreshold region. The voltage V4 generated at node N12 is equal to V_{SG_MP4}−V_{SG_MP3}. Since transistor MP3 with a higher threshold voltage is less sensitive to the absolute temperature compared to transistor MP4 with a lower threshold voltage, the voltage V4 generated at node N12 is complementary to the absolute temperature (e.g., CTAT). Additionally, since transistors MP3 and MP4 are devices with different threshold voltages that are fabricated using different processes, the source-to-gate voltages V_{SG_MP4} and V_{SG_MP3} have a weak correlation or dependency with respect to the absolute temperature, thereby improving (i.e., reducing) the inaccuracy of the voltage V4 generated by the voltage source 400B.

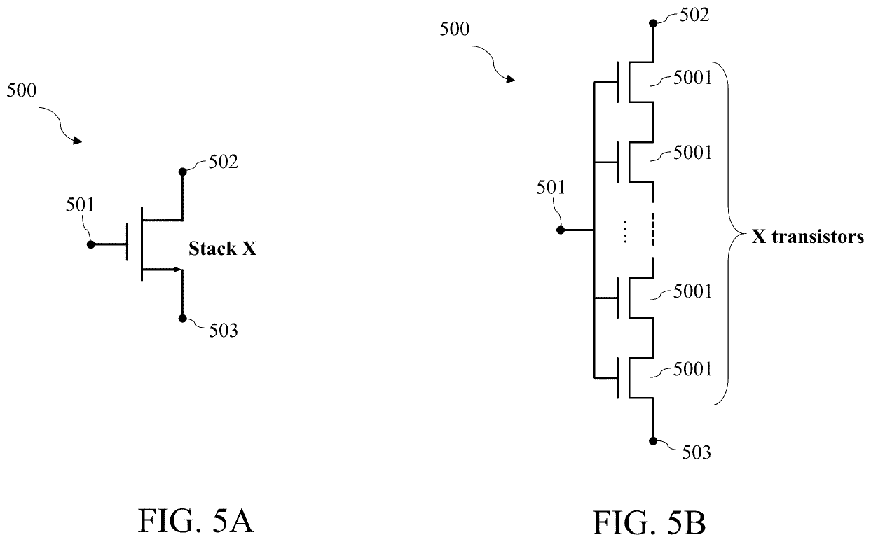

FIG. 5A is a diagram of a stacked gate device in accordance with some embodiments of the present disclosure. FIG. 5B is an equivalent circuit diagram of the stacked gate device in FIG. 5A.

In some embodiments, a stacked gate device 500, also known as “stack X” in FIG. 5A, may be regarded as a three-terminal transistor device with a gate terminal 501, a source/drain (S/D) terminal 502, and a (S/D) terminal 503. The equivalent circuit diagram of the stacked gate device 500 includes a plurality of transistors 5001 arranged in a cascode structure or a stack structure, as shown in FIG. 5B. The total number of stacked transistors 5001 is denoted as an integer X. For example, the gate terminals of the transistors 5001 are connected together to form the gate terminal 501 of the stacked gate device 500. Additionally, the transistors 5001 may be N-type FETs, and the N-type channels of the transistors 5001 (e.g., X transistors 5001) are connected in series between the (S/D) terminal 502 and the (S/D) terminal 503 of the stacked gate device 500. For example, the (S/D) terminal of the first transistor 5001 serves as the (S/D) terminal 502 of the stacked gate device 500, and a (S/D) terminal of the first transistor 5001 is connected to a (S/D) terminal of the second transistor 5001, a (S/D) terminal of the second transistor 5001 is connected to a (S/D) terminal of the third transistor 5001, and so forth. In other words, for each integer n between 1 to X−1, the (S/D) terminal of the n-th transistor 5001 is connected to the (S/D) terminal of the (n+1)-th transistor 5001. Accordingly, the (S/D) terminal of the last transistor 5001 (i.e., X-th transistor 5001) serves as the (S/D) terminal 503 of the stacked gate device 500.

In some embodiments, the gate-to-source voltage Vgs of the stacked gate device 500 can be expressed by formula (3) as follows.

$$Vgs = V th + \sqrt{\frac{2 \cdot I \cdot L 1}{μ \cdot Cox \cdot W 1}} \qquad ( 3 )$$

In formula (3), Vth denotes the threshold voltage of the stacked gate device 500; I denotes the bias current Ibias flowing through the stacked gate device 500; L1 and W1 denotes the channel length and channel width of the stacked gate device 500, respectively; Cox denotes the gate oxide capacitance of the stacked gate device 500 per unit area; u denotes the mobility of electrons. It should be noted that as the temperature increases, the electrons become more energetic and the energy barrier between the first (S/D) terminal 502 and the channel of transistor MN1 is lower, allowing more carriers to be present in the channel, which in turn reduces the threshold voltage. In other words, when the bias current I is fixed, the threshold voltage Vth decreases as the temperature increases, causing the gate-to-source voltage Vgs of the stacked gate device 150 to monotonically decrease with the absolute temperature (e.g., complementary to the absolute temperature, CTAT).

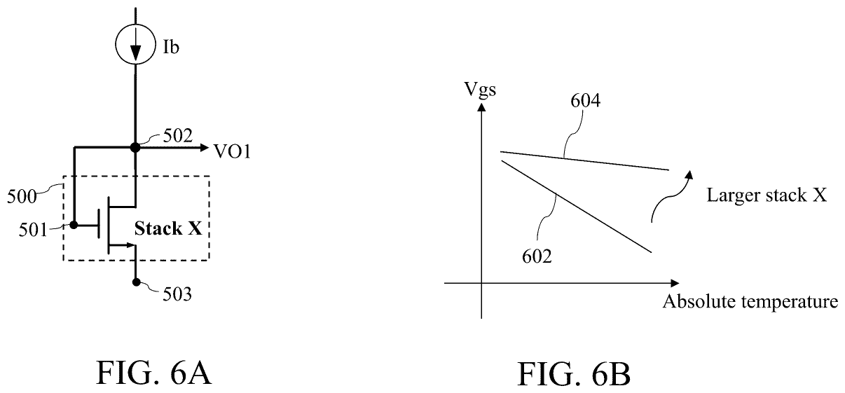

FIG. 6A is a schematic diagram of a stacked gate device in a diode-connected configuration in accordance with some embodiments of the present disclosure. FIG. 6B is a diagram illustrating variations of a voltage-temperature curve of the stacked gate device in FIG. 6A.

In some embodiments, the stacked gate device 500 is in a diode-connected configuration, indicating that the gate terminal 501 of a stacked gate device 500 is connected to the (S/D) terminal 502 of the stacked gate device 500, and a bias current Ib is provided to the stacked gate device 500, as shown in FIG. 6A. In such case, the voltage difference (e.g., gate-to-source voltage) Vgs between the gate terminal 501 and (S/D) terminal 503 of the stacked gate device 500 decreases as the absolute temperature of the stacked gate device X increases, as shown by curve 602 in FIG. 6B. Additionally, the downward slope of the voltage-temperature curve depends on the number of stacked transistors within the stacked gate device X. For example, as the number of stacked transistors increases (e.g., a larger stack X), the slope of the V-T curve decreases, as shown by curve 604 in FIG. 6B, indicating that the voltage difference Vgs between the gate terminal 501 and the (S/D) terminal 503 of the stacked gate device X becomes less sensitive to changes in absolute temperature. As a result, the output voltage VO1 generated by the stacked gate device 500 monotonically decreases in accordance with the absolute temperature (e.g., complementary to the absolute temperature, CTAT). Accordingly, the stacked gate device 500 in the configuration shown in FIG. 6A can be regarded as a CTAT device.

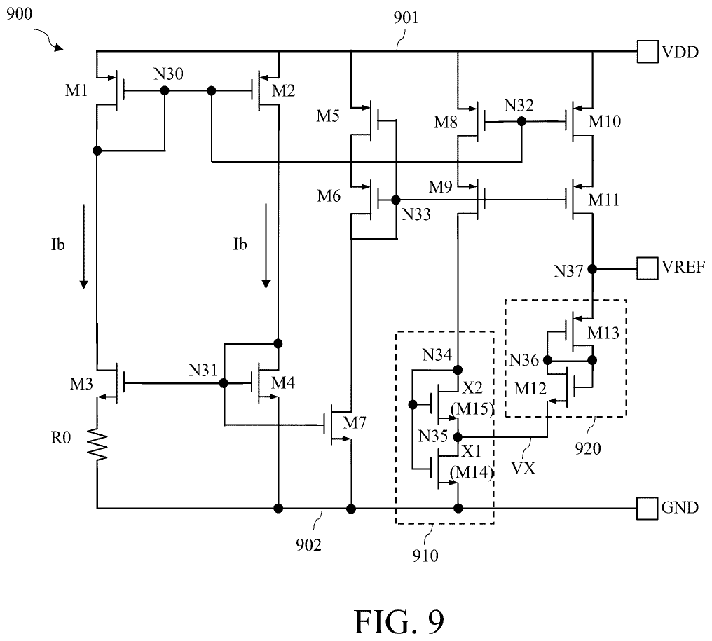

In some embodiments, the stacked gate device 500 in the configuration shown in FIG. 9 (e.g., X1 and X2) has a similar downward V-T curve as shown by curve 602 in FIG. 6B. As the number of stacked transistors increases (e.g., a larger stack X), the downward slope of the V-T curve decreases, as shown by curve 604 in FIG. 6B, indicating that the voltage difference Vgs between the gate terminal 501 and the (S/D) terminal 503 of the stacked gate device X becomes less sensitive to changes in absolute temperature. That is, the downward slope of the V-T (Vgs vs. absolute temperature) curve of the stacked gate device 500 can become less steep as the number of stacked transistors within the stacked gate device 500 increases. This mechanism for the V-T curve can be applied to the stacked gate devices X1 and X2 shown in FIG. 9.

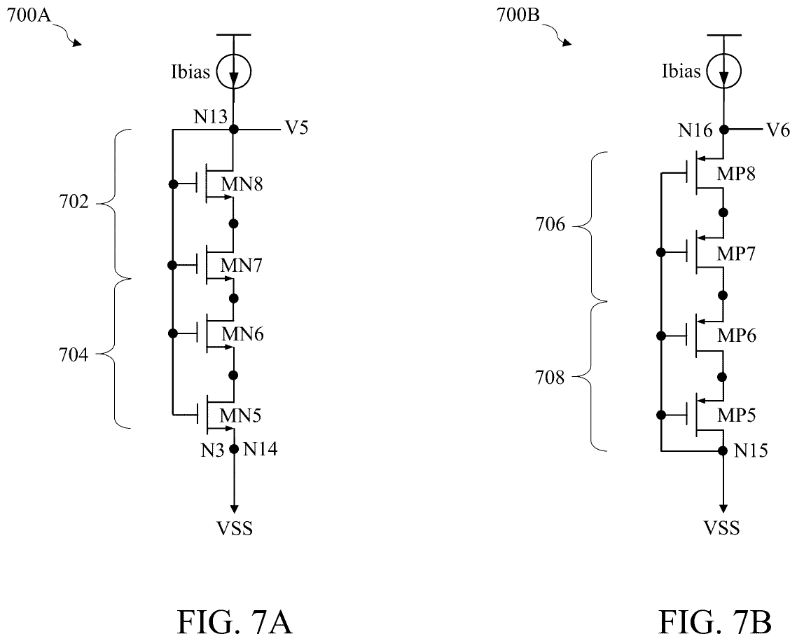

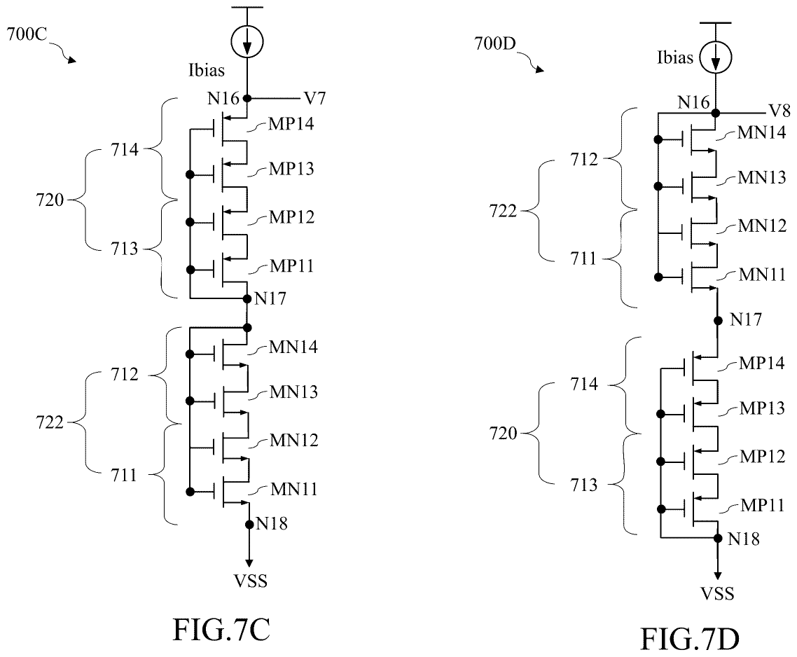

FIG. 7A is a circuit diagram of a voltage source in accordance with yet another embodiment of the present disclosure.

In some embodiments, the first voltage source 120 (e.g., a CTAT voltage source) of the voltage reference circuit 100 shown in FIG. 1 can be implemented using the voltage source 700A in FIG. 7A. The voltage source 700A is configured to generate a voltage V5 which is CTAT. For example, the voltage source 700A is a stacked gate device which includes a first portion 702 and a second portion 704. The first portion 702 includes at least transistors MN7 and MN8 of a first threshold voltage (e.g., Vt_MN7=Vt_MN8=Vtn1). The second portion 704 includes at least transistors MN5 and MN6 of a second threshold voltage (e.g., Vt_MN5=Vt_MN6=Vtn2). Transistors MN5 to MN8 are arranged in a stacked gate structure, as depicted in FIG. 7A. Additionally, the first threshold voltage of transistors MN7 and MN8 is lower than the second threshold voltage of transistors MN5 and MN6, i.e., Vtn1<Vtn2. It should be noted that when transistors within the cascode structure have a common gate, this structure can be referred to as a stacked gate structure.

In some embodiments, the first portion 702 may include more than two transistors, which have the same type and threshold voltage as transistors MN7 and MN8, arranged in the stacked gate structure. The second portion 704 may include more than two transistors, which have the same type and threshold voltage as transistors MN5 and MN6, arranged in the stacked gate structure.

In some embodiments, transistors MN5 and MN6 are designed as SVT devices, LVT devices, or ULVT devices. In some embodiments, transistors MN5 and MN6 are designed as SVT devices, while transistors MN7 and MN8 are designed as LVT devices, ULVT devices, or ELVT devices. In some embodiments, transistors MN5 and MN6 are designed as LVT devices, while transistors MN7 and MN8 are designed as ULVT devices or ELVT devices. In some embodiments, transistors MN5 and MN6 are designed as ULVT devices, while transistors MN7 and MN8 are designed as ELVT devices.

In some embodiments, the first portion 702 and the second portion 704 may be exchanged, indicating that the transistors having a lower threshold voltage are arranged at a higher side of the stacked structure, and the transistors having a higher threshold voltage are arranged at a lower side of the stacked structure.

In some embodiments, since transistors MN5-MN6 and transistors MN7-MN8 are devices with different threshold voltages that are fabricated using different processes, the gate-to-source voltages of transistors MN5-MN6 and transistors MN7-MN8 have a weak correlation or dependency with respect to the absolute temperature, thereby improving (i.e., reducing) the inaccuracy of the voltage V5 generated by the voltage source 700A.

FIG. 7B is a circuit diagram of a voltage source in accordance with yet another embodiment of the present disclosure.

In some embodiments, the first voltage source 120 (e.g., a CTAT voltage source) of the voltage reference circuit 100 shown in FIG. 1 can be implemented using the voltage source 700B in FIG. 7B. The voltage source 700B is configured to generate a voltage V6 which is CTAT. For example, the voltage source 700B is a stacked gate device which includes a first portion 706 and a second portion 708. The first portion 706 includes at least transistors MP7 and MP8 of a first threshold voltage (e.g., Vt_MP7=Vt_MP8=Vtp1). The second portion 708 includes at least transistors MP5 and MP6 of a second threshold voltage (e.g., Vt_MP5=Vt_MP6=Vtp2). Transistors MP5 to MP8 are arranged in a stacked gate structure, as depicted in FIG. 7B. Additionally, the first threshold voltage of transistors MP7 and MP8 is lower than the second threshold voltage of transistors MP5 and MP6, i.e., |Vtp1|<|Vtp2.|

In some embodiments, the first portion 706 may include more than two transistors, which have the same type and threshold voltage as transistors MP7 and MP8, arranged in the stacked gate structure. The second portion 708 may include more than two transistors, which have the same type and threshold voltage as transistors MP5 and MP6, arranged in the stacked gate structure.

In some embodiments, both transistors MP5 and MP6 are designed as SVT devices, LVT devices, or ULVT devices. In some embodiments, both transistors MP5 and MP6 are designed as SVT devices, while both transistors MP7 and MP8 are designed as LVT devices, ULVT devices, or ELVT devices. In some embodiments, both transistors MP5 and MP6 are designed as LVT devices, while both transistors MP7 and MP8 are designed as ULVT devices or ELVT devices. In some embodiments, both transistors MP5 and MP6 are designed as ULVT devices, while both transistors MP7 and MP8 are designed as ELVT devices.

In some embodiments, the first portion 706 and the second portion 708 may be exchanged, indicating that the transistors having a lower threshold voltage are arranged at a higher side of the stacked structure, and the transistors having a higher threshold voltage are arranged at a lower side of the stacked structure.

In some embodiments, since transistors MP5-MP6 and transistors MP7-MP8 are devices with different threshold voltages that are fabricated using different processes, the gate-to-source voltages of transistors MP5-MP6 and transistors MP7-MP8 have a weak correlation or dependency with respect to the absolute temperature, thereby improving (i.e., reducing) the inaccuracy of the voltage V6 generated by the voltage source 700B.

FIG. 7C is a circuit diagram of a voltage source in accordance with yet another embodiment of the present disclosure.

In some embodiments, the first voltage source 120 (e.g., a CTAT voltage source) of the voltage reference circuit 100 shown in FIG. 1 can be implemented using the voltage source 700C in FIG. 7C. The voltage source 700C is configured to generate a voltage V7 which is CTAT. For example, the voltage source 700C is a stacked gate device which includes a first section 720 and a second section 722. The first section 720, which is arranged between nodes N16 and N17, includes a first portion 714 and a second portion 713. The second section, which is arranged between nodes N17 and N18, includes a third portion 712 and a fourth portion 711. Node N16 serves as an output terminal of the voltage source 700C.

In some embodiments, the first section 720 may be similar to the stacked gate structure of the voltage source 700B shown in FIG. 7B. The second section 722 may be similar to the stacked gate structure of the voltage source 700A shown in FIG. 7A.

In some embodiments, the first portion 714 includes at least transistors MP13 and MP14 of a first type having a first threshold voltage (e.g., Vt_MP13=Vt_MP14=Vtp1), while the second portion 713 includes at least transistors MP11 and MP12 of the first type having a second threshold voltage (e.g., Vt_MP11=Vt_MP12=Vtp2). Additionally, the first threshold voltage of transistors MP13 and MP14 is lower than the second threshold voltage of transistors MP11 and MP12, i.e., |Vtp1|<|Vtp2|. In some embodiments, the number of transistors in the first portion 714 equals to that in the second portion 713.

In some embodiments, the first section 720 includes an additional portion including at least two transistors of a fifth threshold voltage different from the first threshold voltage and the second threshold voltage. The additional portion can be arranged at the upper side of the first section 720, at the bottom side of the first section 720, or between the first portion 714 and second portion 713. In some embodiments, the number of transistors in the additional portion is equal to that of the first portion 714 and the second portion 713.

In some embodiments, the third portion 712 includes at least transistors MN13 and MN14 of a second type having a third threshold voltage (e.g., Vt_MN13=Vt_MN14=Vtn1), while the fourth portion 711 includes at least transistors MN11 and MN12 of the second type having a fourth threshold voltage (e.g., Vt_MN11=Vt_MN12=Vtn2). Additionally, the first threshold voltage of transistors MN13 and MN14 is lower than the second threshold voltage of transistors MN11 and MN12, i.e., Vtn1<Vtn2. In some embodiments, the number of transistors in the third portion 712 equals to that in the fourth portion 711. In some embodiments, the number of transistors in the third portion 712 differs from that in the fourth portion 711.

In some embodiments, the second section 722 includes an additional portion including at least two transistors of a sixth threshold voltage different from the third threshold voltage and the fourth threshold voltage. The additional portion can be arranged at the upper side of the second section 722, at the bottom side of the second section 722, or between the third portion 712 and fourth portion 711. In some embodiments, the number of transistors in the additional portion is equal to that of the third portion 712 and fourth portion 711.

In some embodiments, the voltage source 700C includes a stacked gate structure incorporating transistors of the first type with different voltages, and transistors of the second type with different voltages. Since these transistors with different voltages are fabricated using different processes, the gate-to-source voltages thereof exhibit a weak correction or dependency with respect to the absolute temperature, thereby improving (i.e., reducing) the inaccuracy of the voltage V7 generated by the voltage source 700C.

FIG. 7D is a circuit diagram of a voltage source in accordance with yet another embodiment of the present disclosure.

The voltage source 700D shown in FIG. 7D may be similar to the voltage source 700C shown in FIG. 7C, with the difference being that the locations of the first section 720 and the second portion 722 are exchanged in the stacked gate structure of the voltage source 700D. For example, the second section 722 is disposed at the upper side of the stacked gate structure of the voltage source 700D, while the first section 720 is disposed at the bottom side of the stacked gate structure of voltage source 700D.

In some embodiments, the voltage source 700D includes a stacked gate structure incorporating transistors of the first type with different voltages, and transistors of the second type with different voltages. Since these transistors with different voltages are fabricated using different processes, the gate-to-source voltages thereof exhibit a weak correction or dependency with respect to the absolute temperature, thereby improving (i.e., reducing) the inaccuracy of the voltage V8 generated by the voltage source 700D.

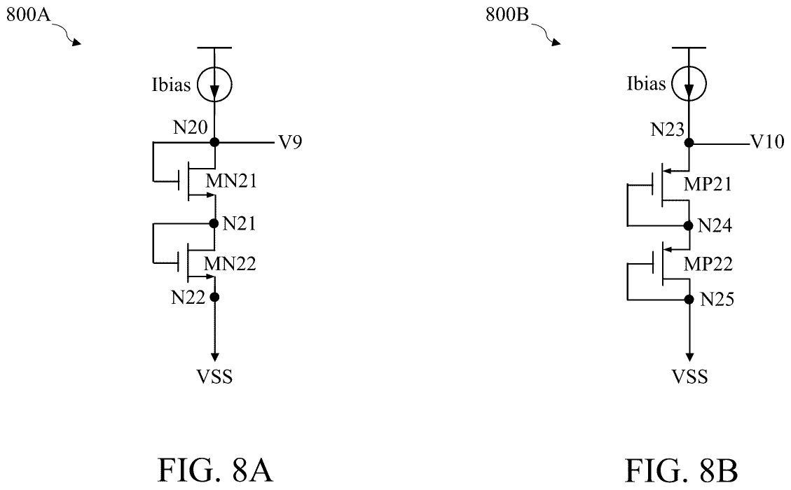

FIG. 8A is a circuit diagram of a voltage source in accordance with yet another embodiment of the present disclosure.

In some embodiments, the voltage source 800A includes transistors MN21 and MN22 of the first type with different threshold voltages. In some embodiments, transistors MN21 and MN22 are in diode-connected configurations. A gate terminal of transistor MN21 is coupled to node N19, which serves as an output terminal of the voltage source 800A. A first S/D terminal of transistor MN21 is coupled to node N20. A second S/D terminal of transistor MN21 is coupled to node N21. A gate terminal of transistor MN22 is coupled to node N21. A first S/D terminal of transistor MN22 is coupled to node N21. A second S/D terminal of transistor MN21 is coupled to node N22, and configured to receive the reference voltage or ground voltage VSS.

In some embodiments, transistor MN21 has a first threshold voltage Vtn1, while transistor MN22 has a second threshold voltage Vtn2. In some embodiments, the first threshold voltage Vtn1 is higher than the second threshold voltage Vtn2. In some embodiments, the first threshold voltage Vtn2 is higher than the second threshold voltage Vtn1. In some embodiments, transistors MN21 and MN22 are designed using two different types of SVT, LVT, ULVT, and ELVT devices.

Since these transistors MN21 and MN22 with different voltages are fabricated using different processes, the gate-to-source voltages thereof exhibit a weak correction or dependency with respect to the absolute temperature, thereby improving (i.e., reducing) the inaccuracy of the voltage V9 generated by the voltage source 800A.

FIG. 8B is a circuit diagram of a voltage source in accordance with yet another embodiment of the present disclosure.

In some embodiments, the voltage source 800B includes transistors MP21 and MP22 of the second type with different threshold voltages. In some embodiments, transistors MP21 and MP22 are in diode-connected configurations. A gate terminal of transistor MP21 is coupled to node N24. A first S/D terminal of transistor MP21 is coupled to node N23, which serves as an output terminal of the voltage source 800B. A second S/D terminal of transistor MP21 is coupled to node N24. A gate terminal of transistor MP22 is coupled to node N25. A first S/D terminal of transistor MP22 is coupled to node N24. A second S/D terminal of transistor MP21 is coupled to node N25, and configured to receive the reference voltage or ground voltage VSS.

In some embodiments, transistor MP21 has a first threshold voltage Vtp1, while transistor MP22 has a second threshold voltage Vtp2. In some embodiments, the first threshold voltage |Vtp1| is higher than the second threshold voltage |Vtp2|. In some embodiments, the first threshold voltage |Vtp2| is higher than the second threshold voltage |Vtp1|. In some embodiments, transistors MP21 and MP22 are designed using two different types of SVT, LVT, ULVT, and ELVT devices.

Since these transistors MP21 and MP22 with different voltages are fabricated using different processes, the gate-to-source voltages thereof exhibit a weak correction or dependency with respect to the absolute temperature, thereby improving (i.e., reducing) the inaccuracy of the voltage V10 generated by the voltage source 800B.

FIG. 9 is a circuit diagram of a voltage reference circuit in accordance with some embodiments of the present disclosure.

In some embodiments, the voltage reference circuit 100 shown in FIG. 1 may be implemented using the voltage reference circuit 900 shown in FIG. 9. The voltage reference circuit 900 is supplied with a power supply voltage VDD through power rail 901, and supplied with a ground voltage GND (or VSS) through power rail 902. The voltage reference circuit 900 includes transistors M1 to M13 and stacked gate devices X1 and X2. Additionally, the stacked gate devices X1 and X2 form a first temperature-sensitive device 910, while transistors M12 and M13 form a second temperature-sensitive device 920.

In some embodiments, transistors M1 and M2 form a current mirror, and a bias current Ib flowing through transistor M1 is mirrored by transistor M2. Thus, the mirrored bias current Ib flows through transistor M2. Additionally, transistors M4 and M3 form another current mirror, and transistors M4 and M7 form yet another current mirror. Thus, the bias current Ib flowing through transistor M4 is mirrored by transistor M7, indicating that the bias current Ib also flows through transistors M5 and M6. It should be noted that transistors M6 and M9 form a current mirror, and transistor M6 and M11 form another current mirror, indicating that the bias current Ib also flows through transistors M8-M9 and transistors M10 and M11, thereby providing the bias current Ib to the first temperature-sensitive device 910 and the second temperature-sensitive device 920.

In some embodiments, the first temperature-sensitive device 910 is configured to generate a voltage VX at node N35. Each of the stacked gate devices X1 and X2 is similar to the stacked gate device 500, but with different numbers of stacked transistors. In some embodiments, the number of stacked transistors within the stacked gate device X1 is larger than that within the stacked gate device X2, indicating that the gate-to-source voltage of the stacked gate device X1 is less sensitive to the absolute temperature than the stacked gate device X2. Thus, the decrement of the gate-to-source voltage Vgs1 of the stacked gate device X1 is less than that of the gate-to-source voltage Vgs2 of the stacked gate device X2 as the absolute temperature increases, indicating that the voltage difference Vgs1−Vgs2 (e.g., voltage VX) increases as the absolute temperature increases. Accordingly, the first temperature-sensitive device 910 functions as a PTAT voltage source, and the voltage VX generated at node N35 is PTAT.

In some embodiments, the stacked gate devices X1 and X2 may be implemented using transistor M14 and M15 with different threshold voltages, with the threshold voltage of transistor M14 being larger than that of transistor M15. Since transistor M14 with a higher threshold voltage is less sensitive to the absolute temperature than transistor M15 with a lower threshold voltage, the decrement of the gate-to-source voltage Vgs1 of transistor M14 is less than that of the gate-to-source voltage Vgs2 of transistor M15 as the absolute temperature increases, indicating that the voltage difference Vgs1−Vgs2 (e.g., voltage VX) increases as the absolute temperature increases. Accordingly, the first temperature-sensitive device 910 functions as a PTAT voltage source, and the voltage VX generated at node N35 is PTAT.

In some embodiments, the second temperature-sensitive device 920 includes transistors M12 and M13. Transistor M12 is the first type, while transistor M13 is the second type. The arrangement of transistors M12 and M13 is similar to the voltage source 300A shown in FIG. 3A, indicating that the voltage across two terminals (e.g., nodes N37 and N35) of the second temperature-sensitive device 920 is CTAT. Therefore, the CTAT voltage generated by the second temperature-sensitive device 920 can be compensated with the PTAT voltage (e.g., VX) generated by the first temperature-sensitive device 910, thereby generating the reference voltage VREF at node N37. It should be noted that the CTAT voltage generated by the second temperature-sensitive device 920 has a lower inaccuracy and a lower temperature coefficient as described in the embodiment of FIG. 3A, the reference voltage VREF generated by the voltage reference circuit 900 also has a lower inaccuracy and a lower temperature coefficient, thereby improving the performance of the voltage reference circuit 900.

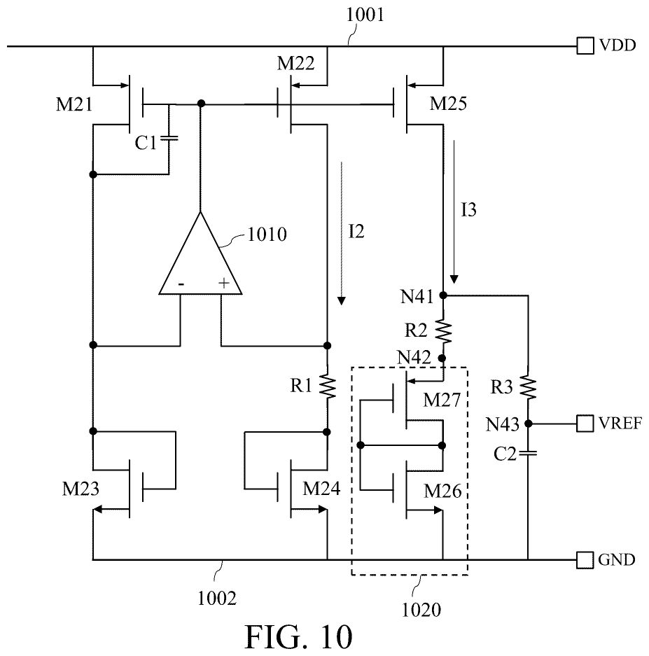

FIG. 10 is a circuit diagram of a voltage reference circuit in accordance with some embodiments of the present disclosure.

In some embodiments, the voltage reference circuit 100 shown in FIG. 1 may be implemented using the voltage reference circuit 1000 shown in FIG. 10. The voltage reference circuit 1000 is supplied with a power supply voltage VDD through power rail 1001, and supplied with a ground voltage GND (or VSS) through power rail 1002. The voltage reference circuit 1000 includes an operational amplifier 1010, transistors M21 to M27.

In some embodiments, due to the virtual ground of the operational amplifier 1010, the voltages at the negative input terminal and the positive input terminal of the operational amplifier 1010 are substantially equal. This indicates that the gate-to-source voltage VGS1 of transistor M23 is equal to the gate-to-source voltage VGS2 of transistor M24 plus the voltage drop across resistor R1. Accordingly, the current I2 can be expressed using formula (4) as follows.

$$I 2 = \frac{VGS 1 - VGS 2}{R 1} \qquad ( 4 )$$

Given that transistor M23 has a higher threshold voltage than transistor M24, it indicates that the gate-to-source voltage VGS1 of transistor M23 is less sensitive to the absolute temperature than the gate-to-source voltage VGS2 of transistor M24. Therefore, the current I2 monotonically increases as the absolute temperature increases, indicating that current I2 is a PTAT current. In some embodiments, transistors M23 and M24 can be replaced by a first stacked gate device and a second stacked gate device, respectively. The number of stacked transistors within the first stacked gate device is larger than that within the second stacked gate device. This implementation can also lead to a PTAT current I2.

In some embodiments, transistors M21 and M22 form a current mirror, while transistors M21 and M25 form another current mirror. The current I2 flowing through transistor M22 is mirrored by transistors M21 and M25. Accordingly, the current I3 flowing through transistor M25 is substantially equal to the current I2, indicating that the current I3 is a PTAT current.

In some embodiments, transistors M26 and M27 form a temperature-sensitive device 1020, which is similar to the voltage source 300A shown in FIG. 3A. This indicates that the voltage across two terminals (e.g., node N42 and ground) of the temperature-sensitive device 1020 is CTAT. Therefore, the voltage at node N41 equals to the voltage generated by the temperature-sensitive device 1020 plus the voltage drop of resistor R2. Since the current I3 is a PTAT current, the voltage drop across resistor R2 is a PTAT voltage. The CTAT voltage generated by the temperature-sensitive device 1020, which has a lower inaccuracy and temperature coefficient, can be compensated with the PTAT voltage across resistor R2 to generate the voltage at node N41. Additionally, during direct-current (DC) operation of the voltage reference circuit 1000, capacitor C2 is opened, and the voltage (e.g., VREF) at node N43 is equal to the voltage at node N41. This indicates that the reference voltage VREF generated by the voltage reference circuit 1000 also has a lower inaccuracy and temperature coefficient, thereby improving the performance of the voltage reference circuit 1000.

In some embodiments, the temperature-sensitive device 1020 shown in FIG. 10 can be replaced by any voltage source described in the embodiments of FIGS. 3B, 4A, 4B, 7A-7D, and 8A-8B, which can also reduce the inaccuracy and temperature coefficient of the reference voltage VREF generated by the voltage reference circuit 1000. In some embodiments, the transistors within the CTAT voltage sources in the embodiments of FIGS. 3A-3B, 4A, 4B, 7A-7D, 8A-8B, and 9-10 operate in the subthreshold region.

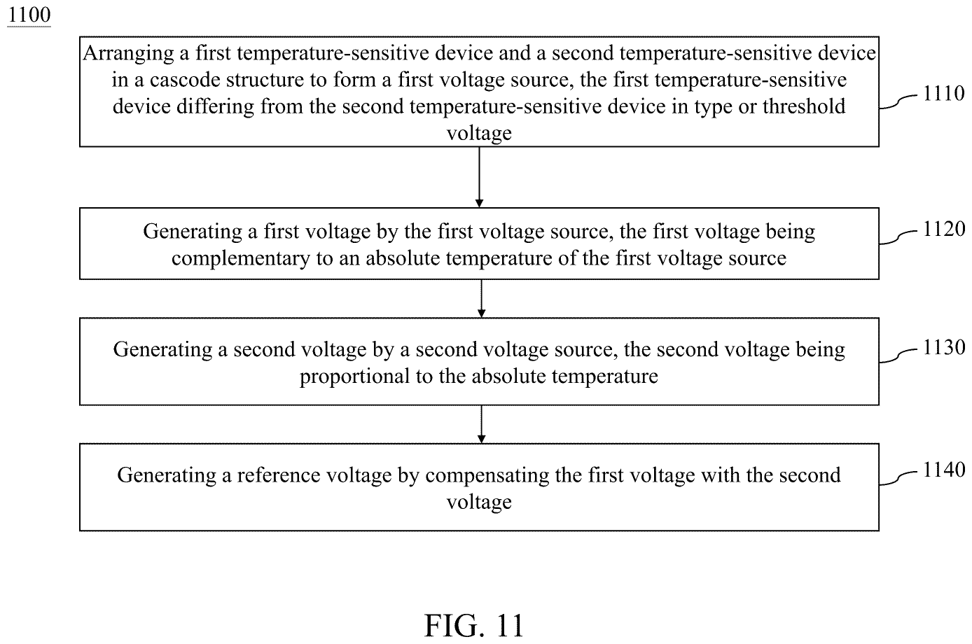

FIG. 11 is a flowchart of a method for generating a power supply voltage with reduced temperature-correlation in accordance with some embodiments of the present disclosure. The sequence in which the operations of method 1100 are depicted in FIG. 11 is for illustration only; the operations of method 1100 are capable of being executed in sequences that differ from that depicted in FIG. 11. It is understood that additional operations may be performed before, during, and/or after the method 1100 depicted in FIG. 11, and that some other processes may only be briefly described herein. The method 1100 includes operations 1110, 1120, 1130, and 1140.

In operation 1110, a first temperature-sensitive device and a second temperature-sensitive device are arranged in a cascode structure to form a first voltage source, wherein the first temperature-sensitive device differs from the second temperature-sensitive device in type or threshold voltage. In some embodiments, the voltage sources with reference to FIGS. 3A-3B, 4A-4B, 7A-7D, and 8A-8D are in a cascode structure with at least two temperature-sensitive devices differing in type or threshold voltage. Additionally, the first temperature-sensitive device and the second temperature-sensitive device have a weak correlation in their gate-to-source voltages with respect to the absolute temperature.

In operation 1120, a first voltage is generated by the first voltage source, wherein the first voltage being complementary to an absolute temperature of the first voltage source. In some embodiments, the first voltage source is a CTAT voltage source.

In operation 1130, a second voltage is generated by a second voltage source, the second voltage being proportional to the absolute temperature. In some embodiments, the second voltage source is a PTAT voltage source.

In operation 1140, a reference voltage is generated by compensating the first voltage with the second voltage. In some embodiments, the first voltage generated by the first voltage source has a reduced inaccuracy and temperature coefficient, and thus the reference voltage can also have a reduced inaccuracy and temperature coefficient.

An aspect of the present disclosure provides a voltage reference circuit which includes a first voltage source and a second voltage source. The first voltage source is configured to generate a first voltage which monotonically decreases with an absolute temperature of the voltage reference circuit. The second voltage source is configured to generate a second voltage, which monotonically increases with the absolute temperature of the voltage reference circuit. The second voltage is compensated with the first voltage to generate a reference voltage. The first voltage source includes a first temperature-sensitive device and a second temperature-sensitive device. The first temperature-sensitive device is of a first type, and the second temperature-sensitive device is of a second type. These devices are arranged in a cascode structure. The first voltage obtained at an output terminal of the first voltage source is equal to a third voltage across the first temperature-sensitive device plus a fourth voltage across the second temperature-sensitive device.

Another aspect of the present disclosure provides a voltage generating circuit which includes a first temperature-sensitive device and a second temperature-sensitive device. The first temperature-sensitive device is of a first type. The second temperature-sensitive device is of a second type. The first temperature-sensitive device and the second temperature-sensitive device are arranged in a cascode structure. An output voltage obtained at an output terminal of the voltage generating circuit is equal to a first voltage across the first temperature-sensitive device plus a second voltage across the second temperature-sensitive device. The output voltage monotonically decreases with an absolute temperature of the voltage generating circuit.

Yet another aspect of the present disclosure provides a method. The method includes the following steps: arranging a first temperature-sensitive device and a second temperature-sensitive device in a cascode structure to form a first voltage source, the first temperature-sensitive device differing from the second temperature-sensitive device in type or threshold voltage; generating a first voltage by the first voltage source, the first voltage being complementary to an absolute temperature of the first voltage source; generating a second voltage by a second voltage source, the second voltage being proportional to the absolute temperature; and generating a reference voltage by compensating the first voltage with the second voltage.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A voltage reference circuit, comprising:
a first voltage source, configured to generate a first voltage which monotonically decreases with an absolute temperature of the voltage reference circuit; and
a second voltage source, configured to generate a second voltage, which monotonically increases with the absolute temperature of the voltage reference circuit, wherein the second voltage is compensated with the first voltage to generate a reference voltage,
wherein the first voltage source comprises a first temperature-sensitive device of a first type and a second temperature-sensitive device of a second type that are arranged in a cascode structure,
wherein the first voltage obtained at an output terminal of the first voltage source is equal to a third voltage across the first temperature-sensitive device plus a fourth voltage across the second temperature-sensitive device.

2. The voltage reference circuit of claim 1, wherein the first type differs from the second type.

3. The voltage reference circuit of claim 2, wherein the first temperature-sensitive device is a first transistor of n-type, and the second temperature-sensitive device is a second transistor of p-type.

4. The voltage reference circuit of claim 3, wherein the first temperature-sensitive device and the second temperature-sensitive device have a common gate terminal.

5. The voltage reference circuit of claim 4, wherein:
the first transistor comprises a gate terminal coupled to a first node, a first terminal coupled to the first node, and a second terminal configured to receive a ground voltage; and
the second transistor comprises a gate terminal coupled to the first node, a first terminal coupled to a second node, and a second terminal coupled to the first node; and
the second node serves as the output terminal of the first voltage source to generate the first voltage.

6. The voltage reference circuit of claim 3, wherein the first transistor and the second transistor are in diode-connected configurations.

7. The voltage reference circuit of claim 6, wherein:
the first transistor comprises a gate terminal coupled to a first node, a first terminal coupled to the first node, and a second terminal coupled to a second node; and
the second transistor comprises a gate terminal coupled to a third node, a first terminal coupled to the second node, and a second terminal coupled to the third node; and
the first node serves as the output terminal of the first voltage source to generate the first voltage.

8. The voltage reference circuit of claim 1, wherein the first type aligns with the second type.

9. The voltage reference circuit of claim 8, wherein:
the first temperature-sensitive device is a first transistor of n-type with a first threshold voltage; and
the second temperature-sensitive device is a second transistor of n-type with a second threshold voltage different from the first threshold voltage.

10. The voltage reference circuit of claim 9, wherein:
the first threshold voltage is higher than the second threshold voltage;
the first transistor comprises a gate terminal coupled to a first node configured to receive a bias current, a first terminal coupled to the first node, and a second terminal coupled to a second node;
the second transistor comprises a gate terminal coupled to the first node, a first terminal coupled to the second node, and a second terminal coupled to a third node configured to receive a ground voltage; and
the second node serves as the output terminal of the first voltage source.

11. The voltage reference circuit of claim 9, wherein:
the first transistor comprises a gate terminal coupled to a first node configured to receive a bias current, a first terminal coupled to the first node, and a second terminal coupled to a second node;
the second transistor comprises a gate terminal coupled to the second node, a first terminal coupled to the second node, and a second terminal coupled to a third node configured to receive a ground voltage; and
the first node serves as the output terminal of the first voltage source.

12. The voltage reference circuit of claim 8, wherein:
the first temperature-sensitive device is a first transistor of p-type with a first threshold voltage;
the second temperature-sensitive device is a second transistor of p-type with a second threshold voltage different from the first threshold voltage; and
the first temperature-sensitive device and the second temperature-sensitive device share a common gate terminal.

13. The voltage reference circuit of claim 12, wherein:
an absolute value of the first threshold voltage is lower than an absolute value of the second threshold voltage;
the first transistor comprises a gate terminal coupled to a first node configured to receive a ground voltage, a first terminal coupled to a second node, and a second terminal coupled to a third node;
the second transistor comprises a gate terminal coupled to the first node, a first terminal coupled to the second node, and a second terminal coupled to the first node; and
the second node serves as the output terminal of the first voltage source.

14. The voltage reference circuit of claim 8, wherein:
the first temperature-sensitive device comprises a plurality of first transistors, each first transistor having a first threshold voltage;
the second temperature-sensitive device comprises a plurality of second transistors, each second transistor having a second threshold voltage different from the first threshold voltage; and
the plurality of first transistors and the plurality of second transistors are arranged in a stacked gate structure sharing a common gate terminal.

15. The voltage reference circuit of claim 2, wherein:
the first temperature-sensitive device comprises a plurality of first transistors arranged in a first stacked gate structure;
the plurality of first transistors are divided into a first portion and a second portion, each first transistor within the first portion having a first threshold voltage, and each first transistor within the second portion having a second threshold voltage different from the first threshold voltage;
the second temperature-sensitive device comprises a plurality of second transistors divided arranged in a second stacked gate structure; and
the plurality of second transistors are divided into a third portion and a fourth portion, each second transistor within the third portion having a third threshold voltage, and each second transistor within the fourth portion having a fourth threshold voltage different from the third threshold voltage.

16. A voltage generating circuit, comprising:
a first temperature-sensitive device of a first type; and
a second temperature-sensitive device of a second type,
wherein the first temperature-sensitive device and the second temperature-sensitive device are arranged in a cascode structure,
wherein an output voltage obtained at an output terminal of the voltage generating circuit is equal to a first voltage across the first temperature-sensitive device plus a second voltage across the second temperature-sensitive device,
wherein the output voltage monotonically decreases with an absolute temperature of the voltage generating circuit.

17. The voltage generating circuit of claim 16, wherein the first voltage and the second voltage monotonically decrease with the absolute temperature.

18. The voltage generating circuit of claim 16, wherein the first type aligns with the second type.

19. The voltage generating circuit of claim 18, wherein:
the first temperature-sensitive device has a first threshold voltage;
the second temperature-sensitive device has a second threshold voltage different from the first threshold voltage; and
the first temperature-sensitive device and the second temperature-sensitive device are fabricated using different processes.

20. A method, comprising:
arranging a first temperature-sensitive device and a second temperature-sensitive device in a cascode structure to form a first voltage source, the first temperature-sensitive device differing from the second temperature-sensitive device in type or threshold voltage;
generating a first voltage by the first voltage source, the first voltage being complementary to an absolute temperature of the first voltage source;
generating a second voltage by a second voltage source, the second voltage being proportional to the absolute temperature; and
generating a reference voltage by compensating the first voltage with the second voltage.
